(19) United States
(12) Patent Application Publication
(10) Pub. No.: US 2013/0230760 A1
(43) Pub. Date: Sep. 5, 2013

(54) BATTERY MODULE

(71) Applicant: DELTA ELECTRONICS, INC., Taoyuan Hsien (TW)

(72) Inventors: Po-Lin Pan, Taoyuan Hsien (TW); Meng-Shun Wu, Taoyuan Hsien (TW)

(73) Assignee: DELTA ELECTRONICS, INC., Taoyuan Hsien (TW)

(21) Appl. No.: 13/707,325

(22) Filed: Dec. 6, 2012

(30) Foreign Application Priority Data
Mar. 1, 2012 (TW) 101106651

(51) Int. Cl. H01M 10/50; H01M 10/42; H01M 2/10

(52) U.S. Cl. CPC H01M 10/5016; H01M 2/1077; H01M 10/4207
USPC 429/120

(57) ABSTRACT

A battery module includes a first battery bracket, a second battery bracket, and a liquid cold heat-dissipating mechanism. The first battery bracket and the second battery bracket are stacked on each other. Each of the first battery bracket and the second battery bracket includes plural hollow portions for accommodating plural battery cells. The liquid cold heat-dissipating mechanism is used for removing heat from the plural battery cells. The liquid cold heat-dissipating mechanism includes an input channel, an output channel, a first flow-channel plate, at least one first connecting member, and at least one second connecting member. After a cooling liquid is introduced into the input channel, the cooling liquid is sequentially transferred through the first end of the first flow-channel plate, the first flow channel, the second end of the first flow-channel plate and the second connecting member, and discharged from the output channel.

### TECHNICAL FIELD OF THE INVENTION

The present invention relates to a battery module, and more particularly to a battery module with a liquid cold heat-dissipating mechanism.

### BACKGROUND ART OF THE INVENTION

Gasoline-powered vehicles are widely used for transportation and become indispensible to our daily lives. With rapid development of the related technologies, mass production of gasoline-powered vehicles brings convenience to the human beings. However, during operations of the gasoline-powered vehicles, the burning of the gasoline may cause air pollution problem and serious environmental problem. In addition, the depletion of the gasoline may lead to global economic crisis.

For protecting the environment, the manufacturers of vehicles are devoted to the development and research of low pollution vehicles. Consequently, there are growing demands on clean and renewable energy. Among various kinds of new energy vehicles, electric vehicles (EV) are more advantageous because of the well-established technologies. In addition, since the power net is widespread over the world, it is convenient to acquire the stable electric energy. As a consequence, electric vehicles (EV) and hybrid electric vehicles (PHEV) are more important in the development of new energy vehicles.

Generally, the electric vehicle or the plug-in hybrid electric vehicle has a built-in chargeable battery as a stable energy source for providing electric energy to the control circuit or the mechanical power devices of the vehicle. In a case that the electric energy stored in the chargeable battery is exhausted, the chargeable battery is usually charged by a charging system.

Generally, during operations of the chargeable battery, a large amount of heat is generated. If the heat is not effectively dissipated away, the performance of the chargeable battery is deteriorated, and the use life of the chargeable battery is shortened.

FIG. 1A is a schematic exploded view illustrating a conventional battery module. The conventional battery module 1 is disclosed in for example US Patent No. 2010/0092849. The conventional battery module 1 comprises an upper casing 10, a lower casing 10, and a plurality of intermediate trays 11. The upper casing 10, the lower casing 10 and the plural intermediate trays 11 collectively define a plurality of grooves 13. The plural grooves 13 are used for accommodating plural battery cells 12. In addition, each battery cell 12 has two terminals 120. Moreover, the plural intermediate trays 11 are stacked on the lower casing 10, and the upper casing 10 is stacked on the plural intermediate trays 11. As a consequence, a multilayered battery module 1 is fabricated.

FIG. 1B is a schematic cross-sectional view illustrating the battery module of FIG. 1A. As shown in FIGS. 1A and 1B, the battery module 1 comprises a plurality of battery cells 12, which are arranged in a stacked form and disposed between the upper casing 10 and the lower casing 10. Moreover, each of the upper casing 10 and the lower casing 10 has a plurality of openings 100, and each of the plural intermediate trays 11 also has a plurality of openings 110. After the upper casing 10, the plural intermediate trays 11, the lower casing 10 and the battery cells 12 are combined together to form the battery module 1, as shown in FIG. 1B, a vacant space 14 is formed within the battery module 1. The vacant space 14 is served as an airflow channel for allowing the airflow to go through. In a case that an active heat-dissipating device such as a fan (not shown) is employed, the heat generated by the battery cells 12 may be dissipated away through the vacant space 14. However, the efficiency of removing the heat from the battery cells 12 or the battery module 1 by the airflow is usually unsatisfied.

From the above discussions, the plural battery cells 12 are arranged between the upper casing 10 and the adjacent intermediate tray 11, between every two adjacent intermediate trays 11 and between the lower casing 10 and the adjacent intermediate tray 11. If one of the upper casing 10, the intermediate trays 11 and the lower casing 10 is slid or shifted in response to an external force, the soldering materials on the battery cells 12 and their terminals 120 are possibly deviated. Under this circumstance, the reliability of the soldering materials at the terminals 120 will be impaired.

### SUMMARY OF THE INVENTION

The present invention provides a battery module with honeycomb-shaped battery brackets for accommodating a plurality of battery cells. Moreover, after the battery cells are accommodated within the battery brackets, the battery cells can be securely fixed by a plurality of thermal pads. Consequently, the possibility of vibrating or rotating the battery cells will be minimized.

The present invention also provides a battery module with a liquid cold heat-dissipating mechanism for removing the heat from plural battery cells. Consequently, the battery module has enhanced heat-dissipating efficiency.

In accordance with an aspect of the present invention, there is provided a battery module. The battery module includes a first battery bracket, a second battery bracket, and a liquid cold heat-dissipating mechanism. The first battery bracket and the second battery bracket are stacked on each other. Each of the first battery bracket and the second battery bracket includes a plurality of hollow portions for accommodating a plurality of battery cells. The liquid cold heat-dissipating mechanism is used for removing heat from the plural battery cells by using a cooling liquid. The liquid cold heat-dissipating mechanism includes an input channel, an output channel, a first flow-channel plate, at least one first connecting member, and at least one second connecting member. The first flow-channel plate is arranged between the first battery bracket and the second battery bracket and includes a first flow channel. The at least one first connecting member is connected with the input channel and a first end of the first flow-channel plate. The at least one second connecting member is connected with a second end of the first flow-channel plate and the output channel. After the cooling liquid is introduced into the input channel, the cooling liquid is sequentially transferred through the first end of the first flow-channel plate, the first flow channel, the second end of the first flow-channel plate and the second connecting member, and discharged from the output channel.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic exploded view illustrating the conventional battery module;

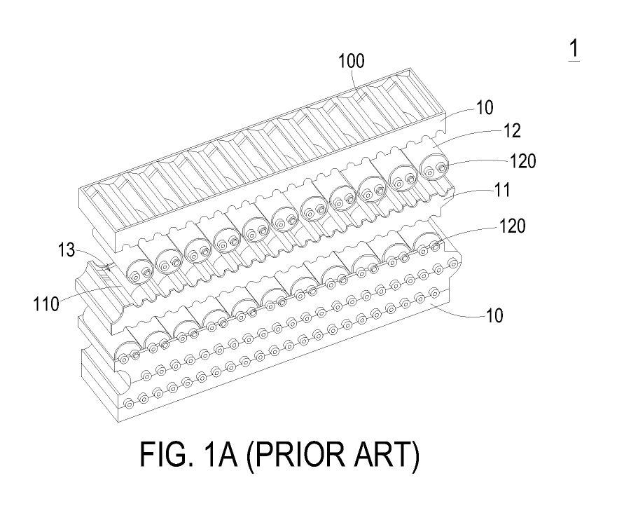

FIG. 1B is a schematic cross-sectional view illustrating a battery module of FIG. 1A;

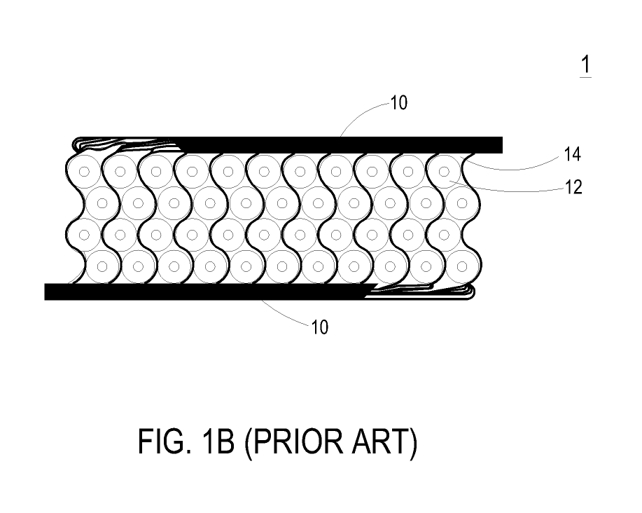

FIG. 2 is a schematic exploded view illustrating a battery module according to a first embodiment of the present invention;

FIG. 3 is a schematic view illustrating the combination of the first battery bracket and the second battery bracket of the battery module according to the first embodiment of the present invention;

FIG. 4 schematically illustrates a perspective view of a first flow-channel plate of the battery module of FIG. 2 and a cutaway view of the first flow-channel plate; and

FIG. 5 is a schematic exploded view illustrating a battery module according to a second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

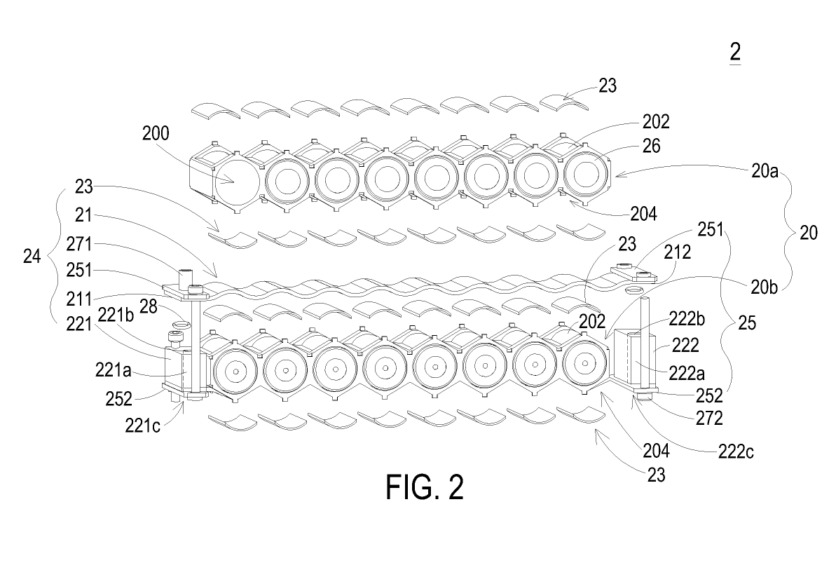

FIG. 2 is a schematic exploded view illustrating a battery module according to a first embodiment of the present invention. As shown in FIG. 2, the battery module 2 comprises a plurality of battery brackets 20 and a liquid cold heat-dissipating mechanism 24. In this embodiment, the plural battery brackets 20 comprise a first battery bracket 20a and a second battery bracket 20b, which are stacked on each other. Moreover, each of the first battery bracket 20a and the second battery bracket 20b comprises a plurality of hollow portions 200 for accommodating a plurality of battery cells 26.

The liquid cold heat-dissipating mechanism 24 utilizes a cooling liquid to remove the heat from plural battery cells 26, which are arranged between the first battery bracket 20a and the second battery bracket 20b. In this embodiment, the liquid cold heat-dissipating mechanism 24 comprises an input channel 271, an output channel 272, a first flow-channel plate 21, a first connecting member 221, and a second connecting member 222. The first connecting member 221 and the second connecting member 222 are located at two opposite sides of the first flow-channel plate 21. In addition, a first junction channel 221a and a second junction channel 222a are disposed within the first connecting member 221 and the second connecting member 222, respectively. The first junction channel 221a of the first connecting member 221 is in fluid communication with the input channel 271. The second junction channel 222a of the second connecting member 222 is in fluid communication with the output channel 272.

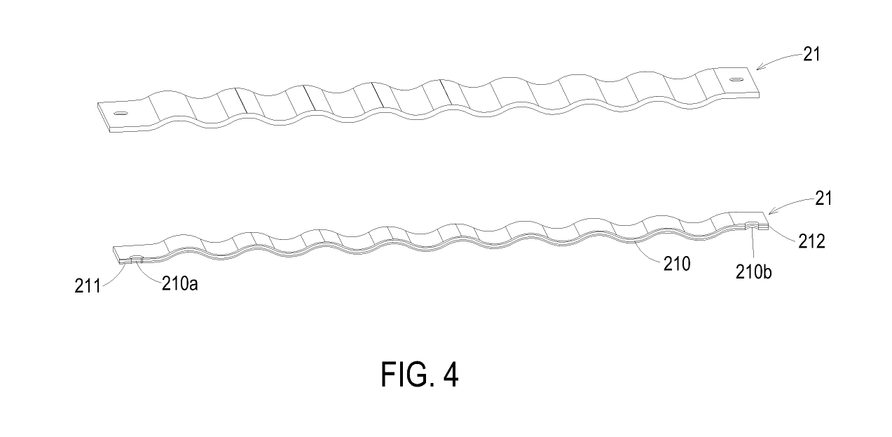

In this embodiment, the first battery bracket 20a and the second battery bracket 20b are stacked on each other, and the first flow-channel plate 21 is arranged between the first battery bracket 20a and the second battery bracket 20b. Moreover, the first flow-channel plate 21 has a flow channel 210 with an inlet 210a and an outlet 210b (see FIG. 4). The inlet 210a is located at a first end 211 of the first flow-channel plate 21, and the outlet 210b is located at a second end 212 of the first flow-channel plate 21. The first sides of the first battery bracket 20a and the second battery bracket 20b are fixed on the first connecting member 221. The second sides of the first battery bracket 20a and the second battery bracket 20b are fixed on the second connecting member 222. The first end 211 of the first flow-channel plate 21 is connected with the first connecting member 221, and the second end 212 of the first flow-channel plate 21 is connected with the second connecting member 222. After the cooling liquid (not shown) is introduced into the input channel 271, the cooling liquid is transferred to the inlet 210a of the flow channel 210 of the first flow-channel plate 21 through the first junction channel 221a of the first connecting member 221, so that the heat from the plural battery cells 26 is dissipated by the cooling liquid. Then, the cooling liquid is transferred to the second junction channel 222a of the second connecting member 222 through the outlet 210b of the flow channel 210. Afterwards, the cooling liquid is discharged from the output channel 272. Since the cooling liquid is transferred through the first connecting member 221, the first flow-channel plate 21 and the second connecting member 222 and then discharged from the output channel 272, the heat from the battery module 2 is dissipated by the cooling liquid.

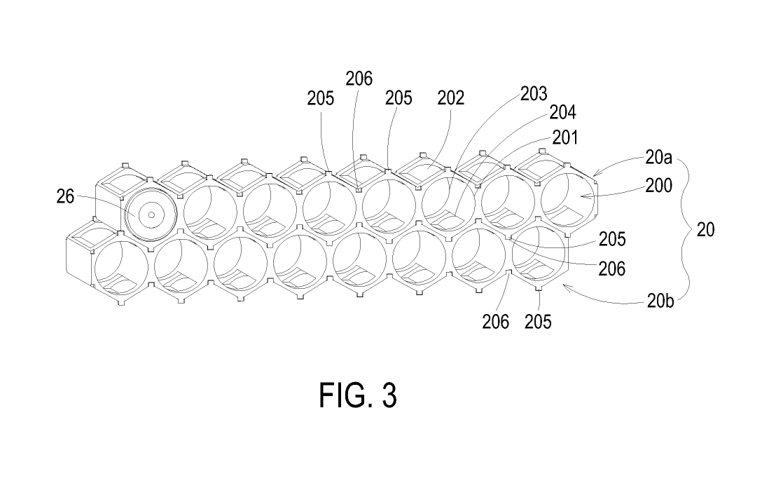

FIG. 3 is a schematic view illustrating the combination of the first battery bracket and the second battery bracket of the battery module according to the first embodiment of the present invention. For clarification and brevity, the first flow-channel plate 21 is not shown in FIG. 3. Please refer to FIGS. 2 and 3. Each of the first battery bracket 20a and the second battery bracket 20b is a honeycomb structure with a plurality of hexagonal units. Preferably, the plural hexagonal units of the honeycomb structure are integrally formed with each other, but are not limited thereto. In some embodiments, the first battery bracket 20a and the second battery bracket 20b are made of nonconductive plastic materials, but are not limited thereto.

Please refer to FIG. 3 again. Each of the first battery bracket 20a and the second battery bracket 20b comprises plural hollow portions 200 corresponding to respective hexagonal units of the honeycomb structure. In this embodiment, the hollow portion 200 is cylindrical space for accommodating a corresponding cylindrical battery cell 26. It is noted that the profile of the hollow portion 200 is not restricted. Moreover, the hollow portion 200 has a first opening 201, a second opening 202, a third opening 203, and a fourth opening 204. The first opening 201 and the third opening 203 are opposed to each other. The second opening 202 and the fourth opening 204 are opposed to each other. In addition, the second opening 202 is disposed adjacent to the first opening 201 and the third opening 203.

In this embodiment, the first opening 201 and the third opening 203 are located at a front side and a rear side of the hollow portion 200, respectively. The second opening 202 and the fourth opening 204 are located at a top side and a bottom side of the hollow portion 200, respectively. Moreover, a corresponding battery cell 26 is introduced into the hollow portion 200 through the first opening 201.

Furthermore, the first battery bracket 20a comprises a plurality of first engaging structures 205, and the second battery bracket 20b comprises a plurality of second engaging structures 206. The plural first engaging structures 205 and the plural second engaging structures 206 are staggered. After the first engaging structures 205 of the first battery bracket 20a are engaged with corresponding second engaging structures 206 of the second battery bracket 20b, the first battery bracket 20a and the second engaging structures 206 are combined together. Due to the engagement between the first engaging structures 205 and respective second engaging structures 206, the first battery bracket 20a and the second battery bracket 20b are securely fixed and stacked on each other.

From the above discussions, since the first battery bracket 20a and the second battery bracket 20b are modularized structures, the first battery bracket 20a and the second battery bracket 20b can be easily fabricated and assembled and advantageous for mass production. Moreover, according to the practical requirements, the number of the plural battery brackets 20, which are stacked on each other, may be varied. Therefore, the number of the plural battery cells 26 may be varied or the plural battery cells 26 may be selectively connected in parallel or in series. Consequently, the applications of the battery module can be enhanced.

Please refer to FIG. 2 again. The liquid cold heat-dissipating mechanism 24 of the battery module 2 further comprises a plurality of thermal pads 23 corresponding to the second openings 202 and the fourth openings 204 of the plural hollow portions 200 of the first battery bracket 20a and the second battery bracket 20b. In a preferred embodiment, the plural thermal pads 23 are inserted into the second openings 202 and the fourth openings 204 of the plural hollow portions 200 and attached on the top sides and bottom sides of the battery cells 26. Consequently, the plural thermal pads 23 provide the functions of buffering and positioning the battery cells 26.

Moreover, in this embodiment, the plural thermal pads 23 are made of flexible and thermally-conductive materials, but are not limited thereto. Consequently, the uses of the plural thermal pads 23 may achieve the isolation efficacy and facilitate buffering and fixing the battery cells 26. Under this circumstance, even if the battery cells 26 are suffered from vibration, the possibility of sliding the battery cells 26 will be minimized. Moreover, through the thermal pads 23, the heat generated by the battery cells 26 can be effectively transferred to the first flow-channel plate 21.

A process of assembling the battery module 2 will be illustrated as follows. Firstly, the plural battery cells 26 are accommodated within corresponding hollow portions 200 of the first battery bracket 20a and the second battery bracket 20b. Then, the plural thermal pads 23 are inserted into the second openings 202 and the fourth openings 204 of the plural hollow portions 200 and attached on the top sides and bottom sides of the battery cells 26. Then, first flow-channel plate 21 is arranged between the first battery bracket 20a and the second battery bracket 20b. Meanwhile, the first sides of the plural thermal pads 23 are attached on the battery cells 26, and the second sides of the plural thermal pads 23 are attached on the first flow-channel plate 21. That is, the heat generated by the battery cells 26 can be effectively transferred to the first flow-channel plate 21, and thus the heat-dissipating efficacy is enhanced.

In this embodiment, the first flow-channel plate 21 is made of a hard material such as copper, aluminum, stainless steel or any other metallic material. Alternatively, the first flow-channel plate 21 is made of a flexible material, but is not limited thereto. As shown in FIG. 4, the first flow-channel plate 21 is a wavy plate with a cambered surface matching the cambered surfaces of the first battery bracket 20a, the second battery bracket 20b and the battery cells 26.

The first flow-channel plate 21 has the flow channel 210 with the inlet 210a and the outlet 210b. The inlet 210a is located at the first end 211 of the first flow-channel plate 21, and the outlet 210b is located at the second end 212 of the first flow-channel plate 21. The cooling liquid is introduced into the flow channel 210 of the first flow-channel plate 21 through the inlet 210a of the flow channel 210, and then discharged from the outlet 210b of the flow channel 210. Consequently, the heat from the battery cells 26 (see FIG. 2) could be dissipated by the cooling liquid.

Please refer to FIG. 2 again. The first end 211 and the second end 212 of the first flow-channel plate 21 are respectively connected with the first connecting member 221 and the second connecting member 222 by a soft soldering process, a chemical welding process, a cured-in-place gasket (CIPG) process, an oil-sealing process or any other coupling means.

In some embodiments, the first connecting member 221 and the second connecting member 222 are rigid bodies made of hard materials in order for connecting and supporting the first battery bracket 20a and the second battery bracket 20b. Alternatively, in some embodiments, the first connecting member 221 and the second connecting member 222 are soft tubes made of flexible materials.

Please refer to FIGS. 2 and 4 again. The first connecting member 221 and the second connecting member 222 have the first junction channel 221a and the second junction channel 222a, respectively. The first junction channel 221a runs through the first connecting member 221, and the second junction channel 222a runs through the second connecting member 222. The first junction channel 221a has an inlet 221b and an outlet 221c, and the second junction channel 222a has an inlet 222b and an outlet 222c. The inlet 221b is located at a top surface of the first connecting member 221, and the inlet 222b is located at a top surface of the second connecting member 222. The outlet 221c is located at a bottom surface of the first connecting member 221, and the outlet 222c is located at a bottom surface of the second connecting member 222. In addition, the inlet 221b of the first junction channel 221a of the first connecting member 221 is in fluid communication with the inlet 210a of the flow channel 210 of the first flow-channel plate 21 and the input channel 271. The outlet 221c of the first junction channel 221a of the first connecting member 221 is a closed structure. The inlet 222b of the first junction channel 222a of the second connecting member 222 is in fluid communication with the outlet 210b of the flow channel 210 of the first flow-channel plate 21. In addition, the outlet 222c of the second junction channel 222a of the second connecting member 222 is further in fluid communication with the output channel 272. After the first battery bracket 20a, the second battery bracket 20b, the plural thermal pads 23 and the first flow-channel plate 21 are combined together, the first connecting member 221 and the second connecting member 222 are located at two opposite sides of the first battery bracket 20a and the second battery bracket 20b, and the first connecting member 221 and the second connecting member 222 are connected with the first flow-channel plate 21. For assembling more layers of battery brackets 20, the battery module 2 comprises a plurality of first connecting members 221 in the stack arrangement and a plurality of second connecting members 222 in the stack arrangement. After the plural first connecting members 221 are stacked on each other, the outlet 221c of the first junction channel 221a in the upper first connecting member 221 is connected with the inlet 221b of the first junction channel 221a in the adjacent lower first connecting member 221. Consequently, the first junction channels 221a between any two adjacent first connecting members 221 are in fluid communication with each other. Similarly, the second junction channels 222a among the plural second connecting members 222 are in fluid communication with each other.

In this embodiment, the battery module 2 further comprises a plurality of seal rings 28. The seal rings 28 are sheathed around the inlet 221b and the outlet 221c of the first junction channel 221a of the first connecting member 221 and the inlet 222b and the outlet 222c of the second junction channel 222a of the second connecting member 222. The uses of the seal rings 28 may prevent leakage of the cooling liquid from the first junction channel 221a and the second junction channel 222a.

The battery module 2 further comprises a fixing mechanism 25. The fixing mechanism 25 comprises at least two upper pressing plates 251 and at least two lower pressing plates 252, which are disposed and fixed on the first connecting member 221 and the second connecting member 222, respectively. As shown in FIG. 2, the input channel 271 is disposed on the upper pressing plate 251 which is fixed on the first connecting member 221. In addition, the output channel 272 is disposed on the lower pressing plate 252 which is fixed on the second connecting member 222.

In this embodiment, the upper pressing plates 251 and the lower pressing plates 252 of the fixing mechanism 25 are made of hard materials such as copper, aluminum, stainless steel or any other metallic material. Alternatively, in some other embodiments, the fixing mechanism 25 is made of a flexible material in order to comply with the first flow-channel plate 21, the first connecting member 221 and the second connecting member 222. Furthermore, the fixing mechanism 25 may be fixed on the first connecting member 221 and the second connecting member 222 by a screwing means or any other fixing means.

From the above discussions, the battery module 2 is assembled by the following steps. Firstly, the plural battery cells 26 are accommodated within corresponding hollow portions 200 of the first battery bracket 20a and the second battery bracket 20b. Then, the plural thermal pads 23 are inserted into the second openings 202 and the fourth openings 204 of the plural hollow portions 200 and attached on the top sides and the bottom sides of the battery cells 26. Then, first flow-channel plate 21 is arranged between the first battery bracket 20a and the second battery bracket 20b. Then, the first connecting member 221 and the second connecting member 222 are disposed on two opposite sides of the first flow-channel plate 21. Afterwards, the top sides and the bottom sides of the first connecting member 221 and the second connecting member 222 are fixed by the fixing mechanism 25. Under this circumstance, a multilayered battery module 2 of the present invention is fabricated.

After the battery module 2 is fabricated, the heat generated by the battery cells 26 is transferred to the first flow-channel plate 21 through the plural thermal pads 23. Since the cooling liquid is introduced into the input channel 271, the cooling liquid is transferred to the inlet 210a of the flow channel 210 of the first flow-channel plate 21 through the first junction channel 221a of the first connecting member 221, the heat from the plural battery cells 26 can be dissipated by the cooling liquid. Then, the cooling liquid is transferred to the second junction channel 222a of the second connecting member 222 through the outlet 210b of the flow channel 210. Afterwards, the cooling liquid is discharged from the output channel 272. Since the cooling liquid is transferred through the first connecting member 221, the first flow-channel plate 21 and the second connecting member 222 and then discharged from the output channel 272, the heat from the battery module 2 is dissipated by the cooling liquid.

In some other embodiments, the first flow-channel plate 21, the first connecting member 221, the second connecting member 222, the input channel 271, the output channel 272 or the fixing mechanism 25 of the battery module 2 may be omitted. Under this circumstance, a vacant space (not shown) within the battery module 2 is created. The vacant space is served as an airflow channel for allowing the airflow to go through. In a case that an active heat-dissipating device such as a fan (not shown) is employed, the heat generated by the battery cells may be dissipated away through the vacant space.

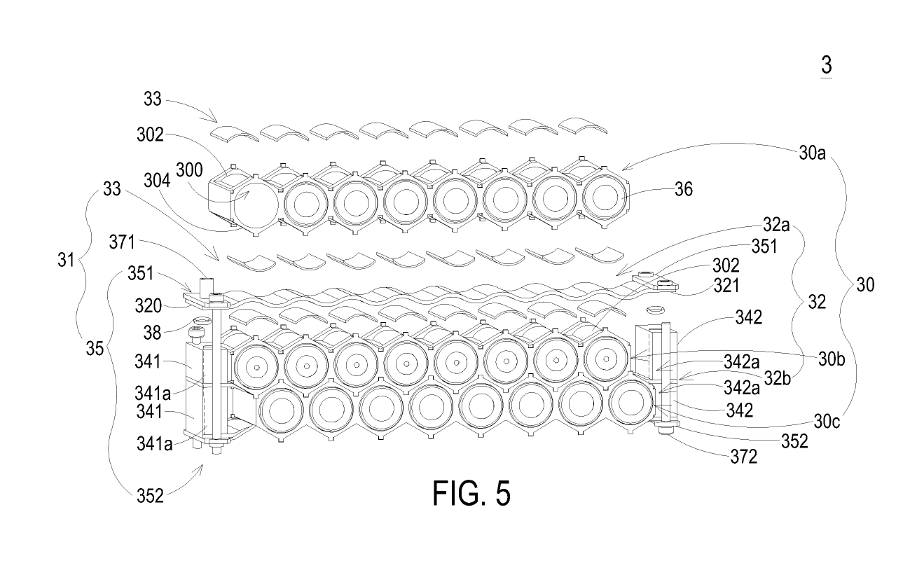

FIG. 5 is a schematic exploded view illustrating a battery module according to a second embodiment of the present invention. As shown in FIG. 5, the battery module 3 comprises a plurality of battery brackets 30 and a liquid cold heat-dissipating mechanism 31. In this embodiment, the plural battery brackets 30 comprise a first battery bracket 30a, a second battery bracket 30b and a third battery bracket 30c, which are stacked on each other. Moreover, each of the first battery bracket 30a, the second battery bracket 30b and the third battery bracket 30c comprises a plurality of hollow portions 300 for accommodating a plurality of battery cells 36. The materials and configurations of the plural battery brackets 30 are identical to the battery module of the first embodiment, and are not redundantly described herein.

In this embodiment, the liquid cold heat-dissipating mechanism 31 comprises an input channel 371, an output channel 372, a plurality of flow-channel plates 32, a plurality of thermal pads 33, a first connecting member 341, a second connecting member 342, and a fixing mechanism 35. The liquid cold heat-dissipating mechanism 31 utilizes a cooling liquid to remove the heat from plural battery cells 36, which are disposed on the plural battery brackets 30. In this embodiment, the first battery bracket 30a, the second battery bracket 30b and the third battery bracket 30c of the battery module 3 are stacked on each other. In addition, the plural flow-channel plates 32 comprise a first flow-channel plate 32a and a second flow-channel plate 32b. The first flow-channel plate 32a is arranged between the first battery bracket 30a and the second battery bracket 30b. The second flow-channel plate 32b is arranged between the second battery bracket 30b and the third battery bracket 30c. The cooling liquid is transferred through the first flow-channel plate 32a and the second flow-channel plate 32b. Consequently, the heat from the battery cells 36 can be dissipated by the cooling liquid.

In this embodiment, each of the first flow-channel plate 32a and the second flow-channel plate 32b has a flow channel (not shown), a first end 320 and a second end 321. The structure of the flow channel is similar to that of the battery module of the first embodiment, and is not redundantly described herein. Similarly, the first flow-channel plate 32a and the second flow-channel plate 32b may be made of hard materials or flexible materials.

Similarly, plural thermal pads 33 are arranged between the first battery bracket 30a and the first flow-channel plate 32a, and aligned with the fourth openings 304 of the plural hollow portions 300 of the first battery bracket 30a. Similarly, additional plural thermal pads 33 are arranged between the first flow-channel plate 32a and the second battery bracket 30b, and aligned with the second openings 302 of the plural hollow portions 300 of the second battery bracket 30b. Similarly, additional plural thermal pads 33 are arranged between the second battery bracket 30b and the second flow-channel plate 32b. Similarly, additional plural thermal pads 33 are arranged between the second flow-channel plate 32b and the third battery bracket 30c. Consequently, the plural thermal pads 33 provide the functions of buffering and positioning the battery cells 36.

In this embodiment, the battery module 3 further comprises a plurality of first connecting members 341 and a plurality of second connecting members 342. The liquid cold heat-dissipating mechanism 31 is connected with the two opposite sides of the first flow-channel plate 32a and the second flow-channel plate 32b through the first connecting members 341 and the second connecting members 342. That is, the plural first connecting members 341 are located at the first ends 320 of the first flow-channel plate 32a and the second flow-channel plate 32b, and the plural second connecting members 342 are located at the second ends 321 of the first flow-channel plate 32a and the second flow-channel plate 32b. In addition, plural first junction channels 341a and plural second junction channels 342a are disposed within the first connecting members 341 and the second connecting members 342, respectively. Moreover, the plural first connecting members 341 are stacked on each other, so that the first junction channels 341a within respective first connecting members 341 are in fluid communication with each other. Similarly, the plural second connecting members 342 are stacked on each other, so that the second junction channels 342a within respective second connecting members 342 are in fluid communication with each other. Moreover, the first junction channels 341a within the topmost first connecting member 341 is in fluid communication with the input channel 371. The second junction channels 342a within the bottommost second connecting members 342 is in fluid communication with the output channel 372.

Moreover, the battery module 3 further comprises a plurality of seal rings 38. The seal rings 38 are sheathed around the inlets and the outlets of the first junction channels 341a and the second junction channels 342a. Furthermore, the fixing mechanism 35 comprises plural upper pressing plates 351 and plural lower pressing plates 352, which are disposed and fixed on the first connecting member 341 and the second connecting member 342, respectively.

From the above discussions, the first battery bracket 30a, the second battery bracket 30b and the third battery bracket 30c are modularized structures and stacked on each other. The first flow-channel plate 32a is arranged between the first battery bracket 30a and the second battery bracket 30b. The second flow-channel plate 32b is arranged between the second battery bracket 30b and the third battery bracket 30c. The first ends 320 of the first flow-channel plate 32a and the second flow-channel plate 32b are in fluid communication with the plural first connecting members 341, and the second ends 321 of the first flow-channel plate 32a and the second flow-channel plate 32b are in fluid communication with the plural second connecting members 342. After the cooling liquid (not shown) is introduced into the liquid cold heat-dissipating mechanism 31 through the input channel 371, the cooling liquid is transferred through the first junction channels 341a of the plural first connecting members 341, and then transferred to the flow channel (not shown) of the first flow-channel plate 32a and the flow channel (not shown) of the second flow-channel plate 32a through the first ends 320 of the first flow-channel plate 32a and the second flow-channel plate 32b. Consequently, the heat from the plural battery cells 36 is dissipated by the cooling liquid. Then, the cooling liquid is transferred to the second junction channels 342a of the plural second connecting member 342 through the second ends 321 of the first flow-channel plate 32a and the second flow-channel plate 32b. Afterwards, the cooling liquid is discharged from the output channel 372. Since the cooling liquid is transferred through the plural first connecting members 341, the plural flow-channel plates 32 and the plural second connecting member 342, the heat from the battery module 3 can be effectively dissipated by the cooling liquid.

In the above two embodiments, the battery module of the present invention comprises plural battery brackets and a liquid cold heat-dissipating mechanism. The plural battery brackets are modularized structures and stacked on each other. The liquid cold heat-dissipating mechanism is arranged between the plural battery brackets and located at bilateral sides of the plural battery brackets. The liquid cold heat-dissipating mechanism is used for removing the heat from the battery cells. It is noted that the number of the battery brackets may be varied according to the practical requirements. For example, the battery module may comprise two, three, four or five layers of battery brackets. Similarly, the number of the thermal pads and the number of the flow-channel plates may be varied according to the number of the battery brackets.

From the above description, the present invention provides a battery module. The battery module of the present invention comprises plural battery brackets and a liquid cold heat-dissipating mechanism. The plural battery brackets are modularized structures and stacked on each other. The plural battery brackets comprise plural hollow portions for accommodating plural battery cells. Moreover, plural thermal pads and a flow-channel plate are arranged between every two adjacent battery brackets. Moreover, a first connecting member and a second connecting member are located at two opposite sides of the battery brackets and the flow-channel plate. In addition, a first junction channel and a second junction channel are disposed within the first connecting member and the second connecting member, respectively. The first junction channel of the first connecting member is in fluid communication with an input channel for transferring a cooling liquid from the first connecting member to the flow channel of the flow-channel plate. Then, the cooling liquid is transferred to the second junction channel of the second connecting member, and discharged from an output channel. Consequently, the heat from the battery cells can be effectively dissipated by the cooling liquid. Since the battery brackets are modularized structures, the battery brackets can be easily fabricated and assembled and advantageous for mass production. Moreover, after the battery cells are accommodated within the hollow portions of the battery brackets, the battery cells can be securely fixed by the thermal pads. Consequently, the possibility of vibrating or rotating the battery cells will be minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A battery module, comprising:
a first battery bracket and a second battery bracket, which are stacked on each other, wherein each of said first battery bracket and said second battery bracket comprises a plurality of hollow portions for accommodating a plurality of battery cells; and
a liquid cold heat-dissipating mechanism for removing heat from said plural battery cells by using a cooling liquid, wherein said liquid cold heat-dissipating mechanism comprises:
an input channel;
an output channel;
a first flow-channel plate arranged between said first battery bracket and said second battery bracket, and comprising a first flow channel;
at least one first connecting member connected with said input channel and a first end of said first flow-channel plate; and
at least one second connecting member connected with a second end of said first flow-channel plate and said output channel,
wherein after said cooling liquid is introduced into said input channel, said cooling liquid is sequentially transferred through said first end of said first flow-channel plate, said first flow channel, said second end of said first flow-channel plate and said second connecting member, and discharged from said output channel.

2. The battery module according to claim 1, wherein each of said first battery bracket and said second battery bracket is a honeycomb structure with a plurality of hexagonal units, wherein said plural hexagonal units of said honeycomb structure are integrally formed with each other.

3. The battery module according to claim 1, wherein said hollow portion has a first opening and a second opening, said second opening is disposed adjacent to said first opening, and a corresponding battery cell is introduced into said hollow portion through said first opening.

4. The battery module according to claim 3, wherein said hollow portion has a third opening and a fourth opening, said first opening and said third opening are opposed to each other, and said second opening is disposed adjacent to said third opening.

5. The battery module according to claim 4, wherein said liquid cold heat-dissipating mechanism further comprises a plurality of thermal pads corresponding to said second openings and said fourth openings of said plural hollow portions of said first battery bracket and said second battery bracket.

6. The battery module according to claim 5, wherein said plural thermal pads are made of flexible and thermally-conductive materials, so that said plural thermal pads are electrically insulated and thermally conductive.

7. The battery module according to claim 1, wherein said first battery bracket comprises a plurality of first engaging structures, and said second battery bracket comprises a plurality of second engaging structures, wherein said plural first engaging structures and said plural second engaging structures are staggered.

8. The battery module according to claim 7, wherein after said first engaging structures of said first battery bracket are engaged with corresponding second engaging structures of said second battery bracket, said first battery bracket and said second engaging structures are combined together.

9. The battery module according to claim 1, wherein a first junction channel and a second junction channel are disposed within said first connecting member and said second connecting member, respectively, wherein each of said first junction channel and said second junction channel has an inlet and an outlet.

10. The battery module according to claim 9, wherein said battery module further comprises a plurality of seal rings, which are located at said inlet and said outlet of said first junction channel of said first connecting member and said inlet and said outlet of said second junction channel of said second connecting member.

11. The battery module according to claim 9, wherein said at least one first connecting member comprises plural first connecting members, and said at least one second connecting member comprises plural second connecting members, wherein said plural first connecting members are stacked on each other, and said first junction channels of said plural first connecting members are in fluid communication with each other, wherein said plural second connecting members are stacked on each other, and said second junction channels of said plural second connecting members are in fluid communication with each other.

12. The battery module according to claim 11, wherein said battery module further comprises a third battery bracket, wherein said first battery bracket, said second battery bracket and said third battery bracket are stacked on each other, wherein a second flow-channel plate is arranged between said second battery bracket and said third battery bracket and comprises a second flow channel, wherein a first end of said second flow-channel plate is connected with a corresponding first connecting member, and a second end of said second flow-channel plate is connected with a corresponding second connecting member, wherein after said cooling liquid is introduced into said input channel, said cooling liquid is sequentially transferred through said plural first connecting members, said first ends of said first flow-channel plate and said first ends of said second flow-channel plate, said first flow channel and said second flow channel, said second ends of said first flow-channel plate and said second ends of said second flow-channel plate and said plural second connecting members, and discharged from said output channel.

13. The battery module according to claim 12, wherein said battery module further comprises a fixing mechanism, wherein said fixing mechanism comprises at least two upper pressing plates and at least two lower pressing plates for fixing said first connecting member and said second connecting member.
